(19) United States
(12) Patent Application Publication
(10) Pub. No.: US 2003/0064720 A1
(43) Pub. Date: Apr. 3, 2003

(54) System and method for generating communication network performance alarms

(76) Inventors: Daniel Valins, San Diego, CA (US); Todd Ruth, Valley Center, CA (US); Philip Cochran, Poway, CA (US)

Correspondence Address: COATS & BENNETT, PLLC, P O BOX 5, RALEIGH, NC, 27602, US

(21) Appl. No.: 09/971,305

(22) Filed: Oct. 3, 2001

(51) Int. Cl. H04Q 7/20

(52) U.S. Cl. 455/423; 455/424; 455/63

(57) ABSTRACT

Statistical processing of event outcomes, such as call attempts or handoff attempts, allows reliable generation of performance alarms within a communication network without requiring analysis of historic performance data. Base station controllers might implement such statistical processing so that the controllers themselves rather than other, further removed network management entities generate performance alarms. Attendant advantages include but are not limited to relatively fast and reliable alarm generation using relatively small sample sets. These and other advantages permit detecting and reporting performance alarm conditions more quickly without sacrificing alarm generation reliability.

### BACKGROUND OF THE INVENTION

The present invention generally relates to communication networks, and particularly relates to statistically based performance alarm generation within such systems.

Communication systems, such as wireless communication networks used in cellular radio systems, are complex aggregations of interdependent entities, with each entity playing a role in the overall functionality of the system. For example, in a wireless communication system, radio base stations (RBSs) provide radio resources that support RF signaling between access terminals and the network. Base station controllers (BSCs), as suggested by the name, provide control and management of the RBSs, and route call traffic and other operational information to and from other entities within the network.

Traditionally, these other network entities include network management entities, which oftentimes accumulate performance or operational data from elsewhere in the network, such as from one or more BSCs within the network. Performance monitoring typically requires processing this historic data and, in some instances, comparing current results to past results. Trend analysis thus provides a basis for assessing the operational health of the network in question, and may provide valuable insight into the overall efficiency and reliability of the network.

Of more immediate value, performance monitoring identifies network operations experiencing unacceptably high failure or problem rates. A BSC experiencing high dropped call rates or an inordinate number of call handoff failures represent typical network problems of keen interest to personnel responsible for overseeing network operations.

Several challenges arise in the context of performance monitoring and alarm generation as might be used to identify and indicate the BSC problems above. First, data analysis underlying identification of the performance problem must be reliable, yet allow for relatively quick identification of the problem. One approach to reliability uses trending where historic data records are accumulated from relevant performance data over multiple and sometimes lengthy intervals of time. Processing of this historic data allows determination of performance characteristics, such as event failures, for the network operations associated with the data.

However, certain drawbacks accompany performance monitoring that relies on historical data. These drawbacks include relatively long lag times between the beginning of a performance problem and its identification via historic record-based performance monitoring. Further disadvantages include the need for relatively sizeable amounts of storage space to accommodate the historic record. Storage needs are exacerbated by the tendency of network operators to monitor a number of network event types.

### SUMMARY OF THE INVENTION

The present invention comprises methods and apparatus for performance monitoring and alarm generation within a wireless communication network based on statistical processing techniques that obviate the need for historical data and allow near real-time alarm generation. Event outcomes (success or failure) for a monitored event type are accumulated as a set of Bernoulli trials to form a sample set. The binomial distribution of the sample set is approximated as a Normal or Student's T distribution, on which basis inferential statistical processing is used to determine whether the sample set indicates that a general failure rate of the event type exceeds defined alarm thresholds. If the alarm threshold is exceeded, an alarm for that event type is generated.

Inferential statistical processing in the above approach may entail performing a one or two tailed t-test (or z-score test) using the sample set, and may make use of an essentially arbitrary confidence interval that allows alarm generation to be reliable within a desired degree of confidence. Moreover, by estimating selected statistical parameters for the sample set, such as standard deviation, rather than relying on analysis of historic data or large sample sets of accumulated data, the present invention provides fast and reliable alarm generation.

Eliminating the need for accumulating large data sets allows at least some performance monitoring and alarm generation to move from centralized network management entities and into other network entities directly supporting call processing, such as the base station controllers (BSCs) or radio base stations (RBSs), where such monitoring would otherwise be impractical. This type of local alarm generation avoids the potential delays associated with forwarding call event data for multiple intervals to a centralized network manager for analysis. However, the present invention may coexist with or be part of such centralized monitoring and reporting systems.

### BRIEF DESCRIPTION OF THE DRAWINGS

FIG. 1 is a diagram of an exemplary communication network.

FIG. 2 is a diagram of exemplary logic flow for one embodiment of the present invention.

FIG. 3 is a diagram of exemplary logic flow for another embodiment of the present invention.

FIG. 4 is a graph of the areas of interest involved in t testing.

### DETAILED DESCRIPTION OF THE INVENTION

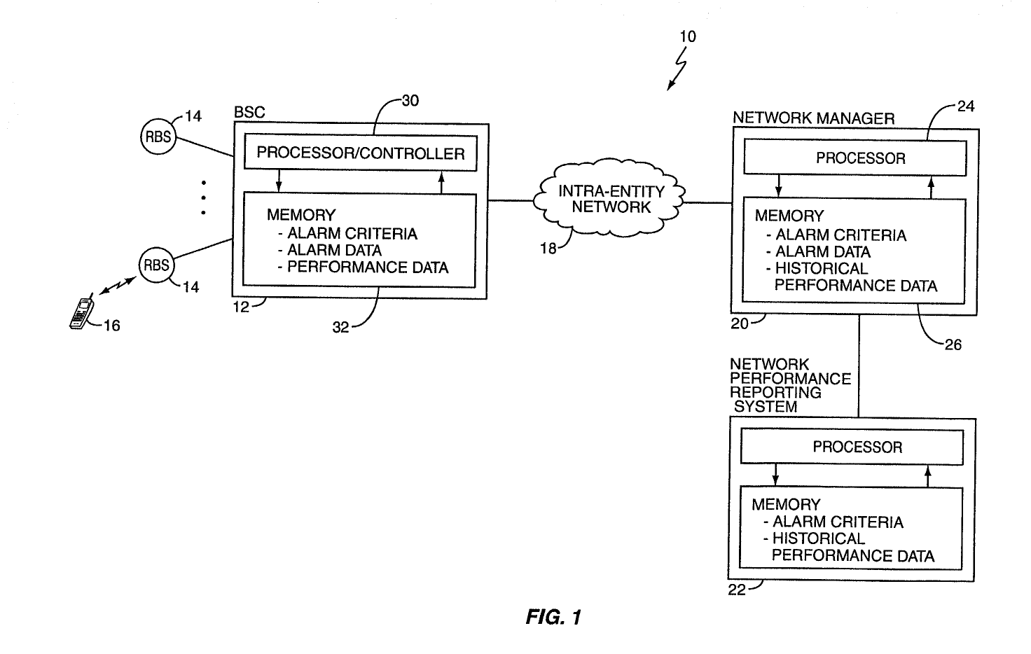

FIG. 1 is a diagram of an exemplary wireless communication network generally referred to by the numeral 10, in which one or more embodiments of the present invention may be practiced. The network 10 comprises one or more base station controllers (BSCs) 12, a plurality of radio base stations (RBSs) 14 supporting wireless communication with access terminals (ATs) 16, an intra-entity network 18, a network manager 20, and a network performance reporting system 22. It should be understood that the network 10 practically comprises additional entities not shown in this simplified model. For example, typical network entities, such as mobile switching centers (MSCs) or packet control functions (PCFs) supporting communication between the BSC 12 and external networks, are not shown in the interest of simplicity.

The BSC 12 manages the RBSs 14, which RBSs 14 provide support for radio frequency communication with a plurality of wireless access terminals (ATs) 16. In turn, the BSC 12 cooperates with network entities not illustrated to route communication traffic to and from the ATs 16. Many aspects of the network's performance and the status of various network components are of significant interest to network operators. When performance falls short of acceptable levels, or when a status condition is violated, network operators understandably desire notification of such circumstances, preferably with an alarm signal.

When discussing alarm generation, it is first helpful to discuss in general the range of events and circumstances giving rise to alarm conditions. A broad category of possible network alarms concerns system or device status. In this category, one might include device-centric alarms such as “power supply failure” or “cabinet door open” alarms. Thus, the RBSs 14, the BSCs 12 and other network entities may have a number of possible alarm conditions associated with the integrity or operational status of their various components and subsystems. Usually, network entities such as the BSC 12 record these kinds of alarms and report them immediately to the network manager 20, for example.

A different class of alarms arises from the failure of one or more portions of the network to meet performance targets. Of course, these performance failures may ultimately relate back to one or more device failures. Traditionally, several network entities are involved in performance-based alarm generation. For example, the BSC 12 may report one or more classes of events to the network manager 24, which may accumulate and analyze these events over potentially long time-periods. Often, the reporting system 22 assists the network manager 24 in these analyses, or in fact performs the analyses for the network manager 20.

With the above framework in mind, the communication network 10 may generate performance alarms in the following manner. Raw performance data associated with the BSC 12 and the RBSs 14, and perhaps other entities not shown, may be accumulated by the BSC 12 over regular intervals of fifteen minutes for example. At the end of each performance data reporting interval, the BSC 12 reports accumulated performance data to the network manager 20. Transfer of performance data between the BSC 12 and the network manager 20 is generally accomplished through the intra-entity network 18, which may be an IP-based network, an IS-41 network, or be based on some other standard determined by the requirements or applicable standards of the network 10.

Here, raw performance data represents call processing and other types of events associated with network operation. For example, the BSC 12 might track how many call attempts it processed over the last reporting interval, and what number of those attempts was unsuccessful. Other likely performance events of interest include but are not limited to call handoffs and dropped calls, wherein the BSC 12 reports the overall number of events and the outcomes of those sets of events. Thus, the BSC 12 might provide raw performance data to the network manager 10 regarding one or more types of communication network events.

The network manager 20, comprising in simplified form a processor 24 and associated memory 26, holds certain information in support of performance monitoring and alarm generation. For example, the network manager's memory 26 may hold alarm criteria representing failure alarm thresholds for one or more event types, alarm data collected from various reporting network entities, and historical performance data representing multiple, accumulated sets of performance event data from the BSC 12, for example.

Using these historical records, the network manager 20 might perform some type of trending or other statistical analysis to determine whether the operation of the network 10 meets defined performance criteria. As an example, the network operator may desire an alarm if the incidence of call attempt failures rises above twenty-percent at the BSC 12. Processing the historical records containing raw event data for call attempts allows the network manager to determine if the observed incidence of call attempt failures exceeds the alarm threshold.

More commonly, however, the network manager 20 relies on the reporting system 22 to perform this type of analysis. Thus, the reporting system 22 generally contains its own processing and memory resources sufficient to process and store historical performance data and alarm criteria transferred from the network manager 20. One advantage of this arrangement is the offloading of the significant processing time associated with operating on potentially large accumulated event data sets, thus freeing the network manager 20 to pursue other tasks.

While such analyses have value in terms of providing longer-term trend views of network operating statistics for report generation, they have disadvantages with regard to alarm generation. For example, if the network manager 20 or its associated reporting system 22 generates performance alarms, such generation is necessarily delayed by the minimum processing intervals of those systems. Because of the amount of historical performance data typically involved in the analyses, there may be an appreciable delay in processing cycles and, therefore, in performance alarm generation.

With the present invention, performance alarms are reliably generated using only a small number of events within a current sample set. By avoiding the use of historical performance data, alarm generation is more timely and practical for implementation in network entities ill suited for accumulating large data sets or for keeping historical performance data. The need for generating large data sets is avoided by performing a unique series of statistical processing steps on a relatively small data set of event outcomes. For example, event outcomes may be accumulated over a relatively short period, such as during the standard alarm reporting intervals of the BSC 12 discussed earlier.

Each event outcome is binary valued, being evaluated on a pass/fail basis. Thus, a series of event outcomes for a given type of communication event represents a set of Bernoulli trials that may be evaluated to determine if the incidence of failure observed within the sample set represents a violation of the defined alarm threshold failure probability p₀. This evaluation involves inferential statistical testing, exemplified by the Student's t-test or the similar z-score test. A set of Bernoulli trials has an inherently binomial distribution but this distribution may be approximated as a normal distribution if several criteria are met.

For a sample set of N Bernoulli trials, where X equals the number of failures within the sample set and p equals the observed failure rate (probability) associated with the event type represented by the sample set, the normal-curve approximation is appropriate when,

N·p>5, (1)

and

N·(1−p)>5, (2)

where

$$p = \frac{X}{N} .$$

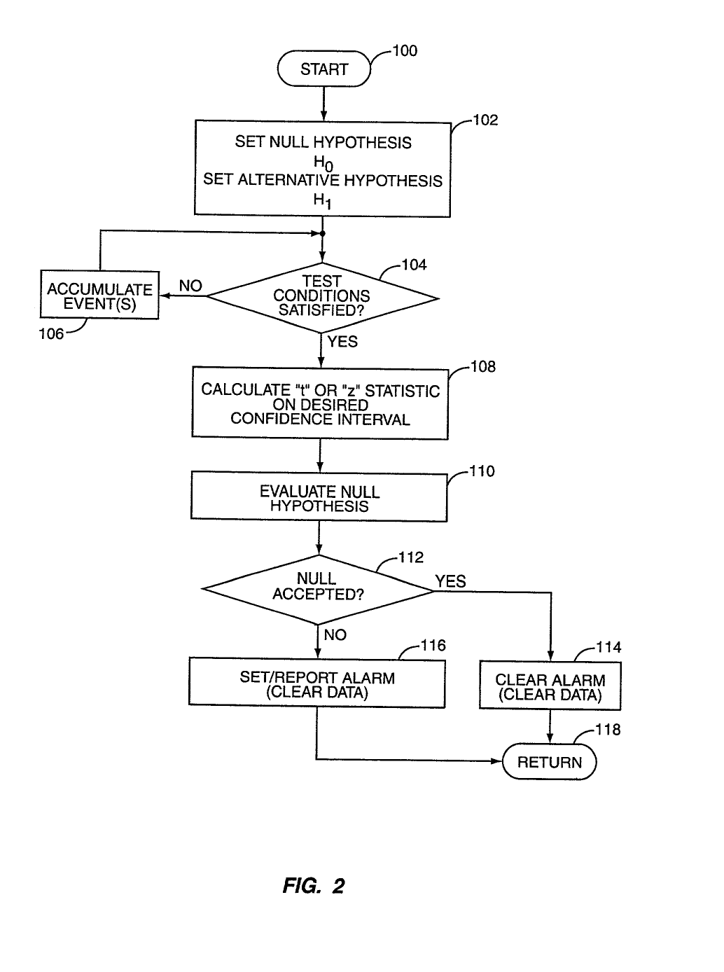

In the context of the above assumptions and goals, FIG. 2 illustrates an exemplary approach to practicing the present invention. Processing starts (step 100) by appropriately setting the null and alternative hypotheses for t-test evaluation (step 102). For example, assume the network operator desires alarm generation when the overall incidence of dropped calls meets or exceeds twenty percent at BSC 12 (i.e., p₀=0.2). The null hypothesis H₀ might be framed as pᵢ<p₀. Here, pᵢ represents the probability of failure inferred from processing the sample set of event outcomes. Similarly, the alternative hypothesis H₁ might be framed as pᵢ>p₀.

As noted above, alarm generation entails accumulating a relatively small sample set of event outcomes and then inferring from that data the overall failure rate of the corresponding event type. This approach requires approximating the binomial distribution of the sample set as a normal distribution. Thus, one technique determines whether the sample set accumulated thus would allow such approximation by checking N·p>5, and N·(1−p)>5 (step 104). If not, one or more additional events are accumulated (step 106), and the test conditions are re-checked. Processing may continue in this manner until enough event outcomes to satisfy the normal-curve approximation requirements are accumulated.

As an example, assume that sixty event outcomes have been accumulated (N=60) and that this set of event outcomes includes thirty failures (X=30). Thus, p=30/60 or 0.5. With these values, the normal approximation tests are satisfied

(Np=60(0.5)=30,

and

N(1−p)=60(1−0.5)=30).

Once the test conditions are satisfied, processing continues with calculation of the t statistic on the desired confidence interval (or z statistic if z-score testing is used). The confidence interval may be arbitrarily set by the network operator, but an exemplary value might be ninety-five percent (0.95) for reliable alarm generation. In practice, the confidence interval may be a configurable value set as needed or desired by the network operator. The confidence interval may be expressed as,

p−t·sₘ<μ<p+t·sₘ, (3)

where μ represents the value of interest, sₘ equals the estimated standard deviation, and t equals the Student's t value.

The estimated standard deviation sₘ may be determined as,

$${s}_{m} = \frac{S}{\sqrt{N}} = \frac{\sqrt{\frac{{X ( 1 - \frac{X}{N} )}^{2} + ( N - {X ( \frac{X}{N} )}^{2}}{N - 1}}}{\sqrt{N}} , \qquad ( 4 )$$

where X and N are, as before, the observed number of failures and the sample set size, respectively.

The t statistic may be found in standard look-up tables as are readily available in statistical literature, or may be calculated as follows,

$$T + ( \frac{1 - T}{2} ) = F ( t ) = {\int }_{- ∞}^{t} ( \frac{Γ ( \frac{n + 1}{2} )}{Γ n π \cdot Γ ( \frac{n}{2} )} ) {( 1 + \frac{{x}^{2}}{n} )}^{- ( \frac{n + 1}{2} )} ⅆ x , \qquad ( 5 )$$

where Γ is the Gamma function, and n equals the degrees of freedom (i.e., N−1). Also, note that the expression

$$T + ( \frac{1 - T}{2} )$$

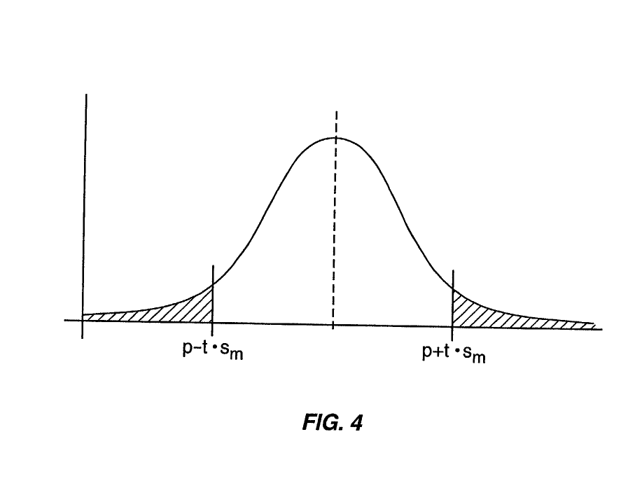

is used to obtain a “one-tailed” value from the “two-tailed” t-test formula. FIG. 4 illustrates the areas of interest under the normal curve associated with the two-tailed t-test.

It should be understood that a one- or two-tailed t-test may be performed, or that the similar z-score test may be performed with subsequent evaluations based on the z statistic rather than the t statistic. Other formulas are available for computing the t statistic and it should be understood that the processor 30 in the BSC 12 (or other processor elsewhere in the network 10) may calculate the t statistic, or obtain it using table look-up methods. With the table look-up approach, the required statistical table or tables may be stored in memory 32 or elsewhere.

With the above calculations, p−t·sₘ<μ becomes,

0.5−(1.671)(0.0651)<μ,

which reduces to 0.39<μ (with the desired ninety-five percent confidence level).

Processing then continues with evaluation of the null hypothesis H₀ (step 110). If the null hypothesis is accepted, one can conclude that the observed failure rate in the sample set is consistent with the proposition that the overall failure rate for the event type of interest is below the alarm threshold set by the network operator. Conversely, if the null hypothesis is rejected, one can infer that the overall failure rate exceeds the threshold value.

The evaluation may be expressed according to the following query:

is

p−t·sₘ>p₀? (6)

Substituting the computed values, the query is 0.39>0.20? The obvious answer is yes, meaning that the null hypothesis H₀ is rejected (step 112). Processing then continues with the BSC 12 setting an alarm indicator or otherwise generating alarm information (step 116). Processing may then return to a calling program or function (step 118). Alarm processing may begin again after a desired interval, or when a controlling program within the BSC software requests it.

Rejecting the null hypothesis H₀ when it should have been accepted is termed a “Type 1” statistical error. The probability of committing a Type 1 statistical error may be limited based on selection of the desired significance level or confidence interval as used in the above t- or z-score testing. Adopting an exemplary confidence interval of ninety-five percent reduces Type 1 errors to no more than 2.5 percent.

If the null hypothesis is accepted (step 112), the BSC 12 might clear any current alarm data for the corresponding event type, as well as clear the current the sample set so that the next alarm evaluation is based on newly accumulated event outcomes. Note that clearing current alarm data does not necessarily entail clearing any older alarm data for the event type that might be stored in memory 32.

The performance alarm information may be stored as part of the alarm data held in memory 32 and reported to the network manager 20 at the next regular alarm-reporting interval. Alternatively, the BSC 12 might immediately report the alarm condition to the network manager 20, or other appropriate supervisory network entity. The manner in which the BSC 12 chooses to report the performance alarm information may be configurable. For example, the network operator may implement alarm generation according to the above logic for a plurality of different network event types. Some event types may have a higher criticality associated with them, and thus might warrant immediate transfer of alarm information from the BSC 12 to the network manager 20. Other less critical event types might have corresponding alarm conditions reported at some predefined reporting interval.

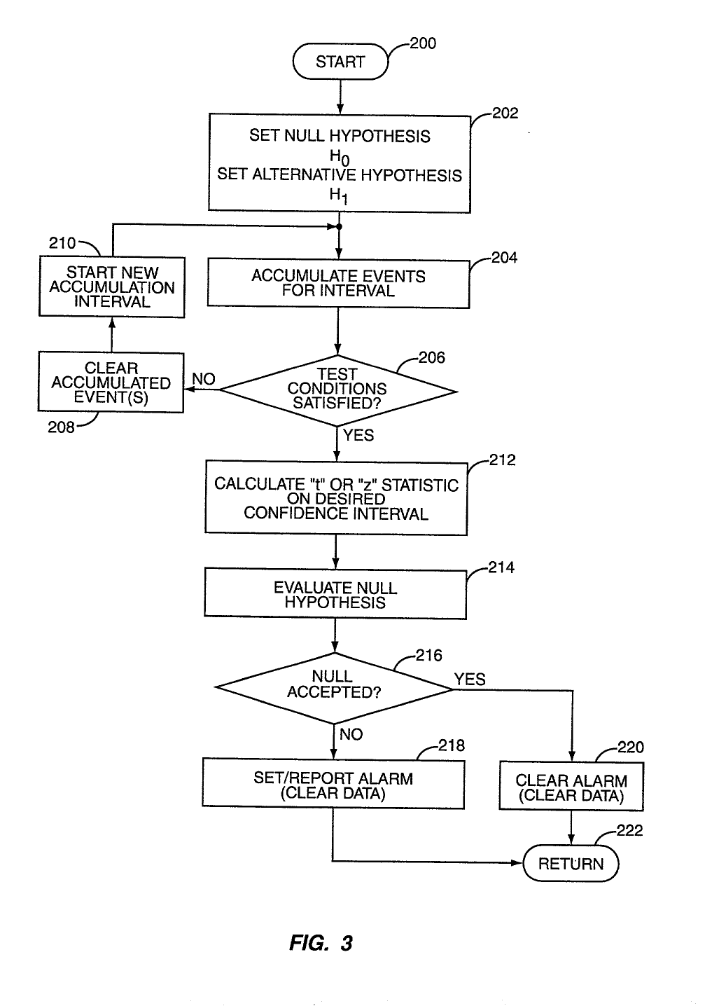

FIG. 3 presents an alternative to the processing logic of FIG. 2 in that the approach to accumulating and checking the set of event outcomes is somewhat different. Processing begins (step 200) with framing the null and alternative hypotheses as before (step 202), but here the processor 30 accumulates event outcomes for a pre-defined interval (step 204). This is in contrast to the approach outlined in FIG. 2 where the processor 30 essentially accumulates event outcomes until the test conditions are satisfied.

Accumulating event outcomes over a defined interval has some advantages. For example, less processing overhead may be required because, instead of repeatedly evaluating (1) and (2) above, the processor 30 performs the test condition evaluations only once at the end of each accumulation interval. If the test conditions are not met (i.e., (1) and (2) are not satisfied) (step 206), the accumulated events are cleared (step 208), a new accumulation interval is started (step 210), and accumulation of event outcomes for the new accumulation interval begins anew (step 204). If the test conditions are satisfied (step 206), processing continues as with the corresponding steps in FIG. 2 above (i.e., processing continues as before with steps 212 through 222).

Whether the logic of FIG. 2 or that of FIG. 3., or some combination or other variation thereof is implemented, it should be understood that the network operator may design the processing flow such that any of the involved variables may be set or configured as desired. Further, it should be understood that the above processing flows may be applied to any number of communication network event types, each event type having its own configurable values, such as alarm threshold, accumulation interval, and reporting preferences (e.g., interval-based reporting or immediate reporting).

It is further worth noting that some event types may be better suited for monitoring in the network manager 20, or even in the RBSs 14, rather than in the BSC 12. By avoiding the need for using historical performance data, the inferential statistical testing methods of the present invention become practical across a range of network entities. Therefore, it should be appreciated that the techniques of the present invention may be implemented in one or more different entities in the communication network 10.

In terms of configuring the network 10 for implementation of the present invention, it may be that the network operator 10 provides or inputs alarm generation configuration information into the network manager 20. Such information may include but is not limited to desired alarm thresholds and reporting intervals. The network manager 20 may then transfer that information to the BSC 12, or to other network entities, depending on which entities are selected to perform alarm generation in accordance with the present invention. Alternatively or additionally, the network operator may directly access the particular network entities involved in alarm generation on an as needed basis.

Of course, those skilled in the art will be enabled by this disclosure to make various modifications and alterations to the present invention as described above. As was noted, the alarm generation techniques of the present invention may be practicably implemented in one or more of a variety of network entities, including BSCs 12, network managers 20, and RBSs 14. In some embodiments, different types of entities may generate performance alarms for different types of communication network events, depending upon which entity is best suited or positioned for monitoring a particular type of event. Further, many of the values used in the exemplary equations above are essentially arbitrary. Thus, alarm thresholds and other variables may be set or adjusted as needed or desired in a particular circumstance. In any case, the above details are exemplary and should not be construed as limiting the scope of the present invention. Indeed, the present invention is limited only by the following claims and the reasonable equivalents thereof.

What is claimed is:

1. A method of alarm generation in a wireless communication network, the method comprising:
accumulating a data set of binomial outcomes for a plurality of events of a desired network event type;
inferring an outcome probability for said desired network event type from said data set using inferential statistical testing; and
generating an alarm if said outcome probability satisfies an alarm condition defined for said event type.

2. The method of claim 1 wherein accumulating the data set of binomial outcomes comprises accumulating binomial outcomes for a plurality of events of the desired network type at least until it is valid to approximate the binomial distribution of the data set as a normal distribution.

3. The method of claim 2 further comprising testing the data set to determine whether the normal distribution approximation is valid.

4. The method of claim 3 further comprising accumulating a new data set if the normal distribution approximation is not valid.

5. The method of claim 3 further comprising accumulating one or more additional binomial outcomes until testing of the data set determines that the normal distribution approximation is valid.

6. The method of claim 1 wherein accumulating a data set of binomial outcomes for a plurality of events of a desired network event type comprises recording the binomial outcome for each one of said plurality of communication network events as one of a successful outcome or a failed outcome.

7. The method of claim 1 wherein inferring an outcome probability from said data set using inferential statistical testing comprises inferring a probability of failure for said event type based on an observed incidence of failure in said data set.

8. The method of claim 7 wherein inferring a probability of failure for said event type based on an observed incidence of failure in said data set comprises performing a t-test or a z-score test.

9. The method of claim 1 wherein said alarm condition is a probability threshold, and wherein generating an alarm if said outcome probability satisfies an alarm condition defined for said event type comprises generating said alarm if said outcome probability exceeds said probability threshold.

10. The method of claim 1 wherein inferring an outcome probability for said desired network event type from said data set using inferential statistical testing comprises:
determining a desired confidence interval for performing a t-test using said data set; and
performing said t-test based on said confidence interval to determine said outcome probability.

11. The method of claim 10 wherein determining a desired confidence interval for said t-test comprises accessing a pre-determined confidence interval value.

12. The method of claim 10 further comprising calculating an estimated standard deviation for said data set in the performance of said t-test.

13. The method of claim 10 further comprising determining a t statistic for said t-test by table look-up.

14. The method of claim 10 further comprising determining a t statistic for said t-test by calculating a statistical formula.

15. The method of claim 1 further comprising performing the steps of claim 1 in a base station controller comprising a portion of said wireless communication network.

16. The method of claim 15 further comprising storing alarm information bearing on generating said alarm at said base station controller.

17. The method of claim 15 further comprising receiving said alarm information from a remote network entity.

18. The method of claim 15 further comprising reporting said alarm condition to a remote network entity.

19. The method of claim 18 wherein reporting said alarm condition comprises reporting said alarm to a network manager.

20. The method of claim 1 further comprising performing the steps of claim 1 in a radio base station comprising a portion of said wireless communication network.

21. The method of claim 1 further comprising performing the steps of claim 1 in a network manager comprising a portion of said wireless communication network.

22. The method of claim 1 further comprising generating alarms for a plurality of different types of communication network events based on inferentially determining outcome probabilities for said plurality of different types of communication network events.

23. The method of claim 22 further comprising storing an alarm threshold as said alarm condition for each of said plurality of different types of communication network events, such that the alarm condition for each event type is evaluated based on the corresponding alarm threshold.

24. The method of claim 1 further comprising defining said alarm condition as a configurable alarm threshold.

25. A method of generating performance alarms in a wireless communication network, the method comprising:
accumulating a sample set as a plurality of event outcomes for a communication event type, said event outcomes being recorded as one of an event failure and an event success;
determining a first failure rate for said plurality of event outcomes based on the number of event failures and event successes;
inferring by statistical analysis a general failure rate for said communication event type based on said first failure rate; and
determining whether an alarm condition exists based on comparing said general failure rate to an alarm threshold failure rate.

26. The method of claim 25 further comprising indicating an alarm condition if said general failure rate exceeds said alarm threshold failure rate.

27. The method of claim 25 wherein said alarm threshold failure rate comprises a pre-defined failure probability value, and wherein inferring by statistical analysis a general failure rate for said communication event type comprises determining a calculated failure probability value.

28. The method of claim 27 wherein determining whether an alarm condition exists based on comparing said general failure rate to said alarm threshold failure rate comprises comparing said calculated failure probability value to said pre-defined failure probability value.

29. The method of claim 25 wherein inferring by statistical analysis a general failure rate for said communication event type comprises performing a t-test using said sample set.

30. The method of claim 29 further comprising performing said t-test on a desired confidence interval.

31. The method of claim 29 further comprising performing said t-test as a one tail t-test.

32. The method of claim 29 further comprising performing said t-test as a two tailed t-test.

33. The method of claim 29 further comprising estimating a standard deviation for said sample set for use in performing said t-test.

34. The method of claim 25 wherein inferring by statistical analysis a general failure rate for said communication event type comprises performing one of a t-test or a z-score test using said sample set.

35. The method of claim 34 further comprising determining whether to perform a t-test or a z-score test based on one or more characteristics of said sample set.

36. The method of claim 25 wherein accumulating a sample set as a plurality of event outcomes for a communication event type comprises recording event outcomes at least until said sample set is suitable for use in inferential statistical analysis to infer said general failure rate.

37. The method of claim 36 further comprising determining whether said sample set is suitable for inferential statistical testing by evaluating one or more values determined as the product of the number of samples in said sample set and an observed incidence of failure for said sample set.

38. The method of claim 37 further comprising determining whether to use a statistical t-test or a statistical z-score test based on the number of samples in said sample set.

39. The method of claim 25 wherein accumulating a sample set as a plurality of event outcomes for a communication event type comprises accumulating event outcomes at least until a binomial distribution of said event outcomes may be approximated as a normal distribution.

40. The method of claim 25 wherein accumulating a sample set as a plurality of event outcomes for a communication event type comprises:
accumulating event outcomes for a defined accumulation interval; and
testing said sample set to determine if the binomial distribution of said event outcomes may be approximated as a normal distribution.

41. The method of claim 40 further comprising:
discarding said sample set if the normal distribution approximation cannot be used;
beginning a new accumulation interval over which a new sample set will be accumulated; and
repeating the test for normal distribution approximation after said new sample set is accumulated.

42. The method of claim 25 further comprising assuming a Student's t-distribution for said sample set, and wherein inferring by statistical analysis a general failure rate for said communication event type comprises performing a t-test on said plurality of event outcomes.

43. The method of claim 25 further comprising defining said alarm threshold failure rate as a configurable alarm threshold failure rate.

44. A network entity for use in a wireless communication network, said network entity comprising a processor to provide performance alarm generation for at least one type of communication event by:
recording a plurality of event outcomes for said communication event type, each said event outcome recorded as one of an event failure and an event success;
determining a first failure rate for said plurality of event outcomes based on the number of event failures and event successes;
inferring by statistical analysis a general failure rate for said communication event type based on said first failure rate; and
determining whether an alarm condition exists based on comparing said general failure rate to an alarm threshold failure rate.

45. The network entity of claim 44 wherein said processor infers by statistical analysis said general failure rate by performing inferential statistical testing using said plurality of event outcomes recorded.

46. The network entity of claim 45 wherein said processor performs said inferential statistical testing as a Student's t-test.

47. The network entity of claim 45 wherein said processor performs said inferential statistical testing as a z-score test.

48. The network entity of claim 44 wherein said processor accumulates event outcomes until a binomial distribution of said plurality of event outcomes may be approximated as a normal distribution.

49. The network entity of claim 44 wherein said processor accumulates event outcomes in each of one or more defined accumulation intervals until a binomial distribution of said plurality of event outcomes accumulated may be approximated as a normal distribution.

50. The network entity of claim 44 further comprising memory, and wherein said alarm threshold failure rate is stored in said memory.

51. The network entity of claim 50 wherein a plurality of said alarm threshold failure rates for a plurality of different communication event types is stored in said memory.

52. The network entity of claim 51 wherein said processor generates performance alarms for said plurality of different communication network event types based on said plurality of alarm threshold failure rates stored in said memory.

53. The network entity of claim 50 wherein said processor accumulates said event outcomes in said memory.

54. The network entity of claim 44 wherein said network entity receives said alarm threshold failure rate from a remote entity.

55. The network entity of claim 44 wherein said processor uses a confidence level used in said statistical testing, such that determination of whether said alarm condition exists is calculated with a desired confidence level.

56. The network entity of claim 44 wherein said processor generates a performance alarm for said type of communication network event if said alarm condition exists.

57. The network entity of claim 56 wherein said network entity notifies a remote entity of said alarm condition.

58. The network entity of claim 44 wherein said network entity generates performance alarms for a plurality of different types of communication events.

59. The network entity of claim 44 wherein said network entity comprises a base station controller.

60. The network entity of claim 44 wherein said network entity comprises a radio base station.

61. The network entity of claim 44 wherein said network entity comprises a network manager.

62. The network entity of claim 44 where said processor uses a configurable alarm threshold failure rate.
